(19) United States
(12) Patent Application Publication
(10) Pub. No.: US 2022/0270029 A1
(43) Pub. Date: Aug. 25, 2022

(54) SHELF INVENTORY MANAGEMENT SYSTEM, SHELF INVENTORY MANAGEMENT METHOD, AND PROGRAM

(71) Applicant: TOYOTA JIDOSHA KABUSHIKI KAISHA, Toyota-shi Aichi-ken (JP)

(72) Inventors: Yuta Itozawa, Nagoya-shi Aichi-ken (JP); Kunihiro Iwamoto, Nagakute-shi Aichi-ken (JP); Hirotaka Komura, Setagaya-ku Tokyo (JP); Yutaro Takagi, Edogawa-ku Tokyo (JP); Yoshiaki Nakamoto, Nisshin-shi Aichi-ken (JP); Junya Ota, Edogawa-ku Tokyo (JP)

(21) Appl. No.: 17/546,454

(22) Filed: Dec. 9, 2021

(30) Foreign Application Priority Data
Feb. 19, 2021 (JP) 2021-025042

(51) Int. Cl. G06Q 10/08

(52) U.S. Cl. CPC G06Q 10/087

(57) ABSTRACT

A shelf inventory management system according to an aspect of the present disclosure includes: a shelf including a plurality of storage boxes, each of which is identified; a mass sensor that detects a mass change of the storage boxes; and a management unit that manages an inventory of articles stored in each of the storage boxes. The management unit determines an article taken out from any of the storage boxes, based on the mass change detected by the mass sensor. The shelf inventory management system further includes a sorting robot that sorts purchased articles into the storage boxes. The management unit controls the sorting robot such that the sorting robot stores different kinds of articles having the same mass in separate storage boxes.

### CROSS-REFERENCE TO RELATED APPLICATION

This application claims priority to Japanese Patent Application No. 2021-025042 filed on Feb. 19, 2021, incorporated herein by reference in its entirety.

### BACKGROUND

### 1. Technical Field

The present disclosure relates to a shelf inventory management system, a shelf inventory management method, and a program.

### 2. Description of Related Art

When managing an inventory of articles stored in a storage box, it is troublesome to give identification information such as an identification (ID) tag to each article and read the identification information by a reader when taking out the articles. To this end, Japanese Unexamined Patent Application Publication No. 2002-316706 (JP 2002-316706 A) discloses an inventory management system that determines the article taken out, based on a mass change of the storage box.

### SUMMARY

The inventors have found the following issue in a shelf inventory management system that determines the article taken out, based on the mass change of the storage box. In the shelf inventory management system as disclosed in JP 2002-316706 A, there is an issue that the article taken out cannot be determined when different kinds of articles having the same mass are stored in one storage box.

The present disclosure has been made in view of such circumstances, and provides a shelf inventory management system capable of reliably determining an article taken out, based on a mass change of a storage box.

A shelf inventory management system according to an aspect of the present disclosure includes: a shelf including a plurality of storage boxes, each of which is identified; a mass sensor that detects a mass change of the storage boxes; and a management unit that manages an inventory of articles stored in each of the storage boxes. The management unit determines an article taken out from any of the storage boxes, based on the mass change detected by the mass sensor. The shelf inventory management system further includes a sorting robot that sorts purchased articles into the storage boxes. The management unit controls the sorting robot such that the sorting robot stores different kinds of articles having the same mass in separate storage boxes.

Further, a shelf inventory management method according to another aspect of the present disclosure is a shelf inventory management method for managing, using a computer, an inventory of articles stored in each of a plurality of storage boxes in a shelf including the storage boxes, each of which is identified. The shelf inventory management method includes: controlling, when sorting purchased articles into the storage boxes, a sorting robot such that the sorting robot stores different kinds of articles having the same mass in separate storage boxes; and determining, when taking out an article from any of the storage boxes, the article taken out based on a mass change of the storage boxes.

Further, a program according to another aspect of the present disclosure is a program for managing, using a computer, an inventory of articles stored in each of a plurality of storage boxes in a shelf including the storage boxes, each of which is identified. When a sorting robot sorts and stores articles in the storage boxes, the program controls the sorting robot such that the sorting robot stores different kinds of articles having the same mass in separate storage boxes. When taking out an article from any of the storage boxes, the program determines the article taken out based on a mass change of the storage boxes.

In the aspect of the present disclosure, the sorting robot is controlled such that the sorting robot stores different kinds of articles having the same mass in separate storage boxes. Therefore, the article taken out can be reliably determined based on the mass change of the storage boxes.

The shelf inventory management system may further include a reader that reads article identification information provided to the article. When it is necessary to store different kinds of articles having the same mass in one storage box, the shelf inventory management system may provide the article identification information to at least one of the different kinds of articles having the same mass. The management unit may permit the sorting robot to store different kinds of articles having the same mass in one storage box when the article is provided with the article identification information. With such a configuration, it is possible to reliably determine the article taken out, based on the mass change of the storage box while saving time and effort.

When it is necessary to store different kinds of articles having the same mass in one storage box, the shelf inventory management system may provide a partition plate equipped with a sensor for detecting an object in the one storage box. The management unit may control the sorting robot such that the sorting robot stores different kinds of articles having the same mass in separate areas partitioned by the partition plate in the one storage box. With such a configuration, it is possible to reliably determine the article taken out, based on the mass change of the storage box while saving time and effort.

The present disclosure can provide a shelf inventory management system capable of reliably determining an article taken out, based on a mass change of a storage box.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a shelf inventory management system according to a first embodiment;

FIG. 2 is a schematic front view showing an example of a configuration of a shelf 50;

FIG. 3 is a schematic side view showing a rail 53 and a lock mechanism 54;

FIG. 4 is a schematic side view showing the rail 53 and the lock mechanism 54;

FIG. 5 is a schematic side view showing the rail 53 and the lock mechanism 54;

FIG. 6 is a schematic side view showing an example of a configuration of a sorting robot 70;

FIG. 7 is a schematic side view showing an example of a configuration of a transfer robot 80;

FIG. 8 is a flowchart showing a shelf inventory management method according to the first embodiment;

FIG. 9 is a block diagram of a shelf inventory management system according to a second embodiment; and

FIG. 10 is a sectional view of a storage box 61 used in a shelf inventory management system according to a third embodiment.

### DETAILED DESCRIPTION OF EMBODIMENTS

Hereinafter, specific embodiments will be described in detail with reference to the drawings. In each drawing, the same or corresponding elements are designated by the same reference signs, and duplicate descriptions are omitted as necessary for the sake of clarity.

### First Embodiment

Configuration of Shelf Inventory Management System

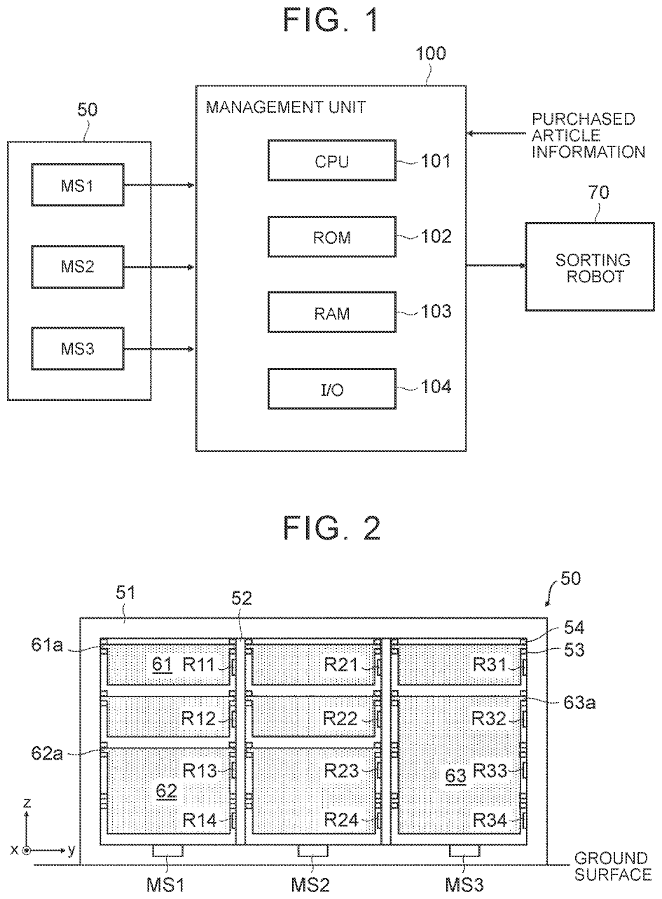

First, a shelf inventory management system according to a first embodiment will be described with reference to FIG. 1. FIG. 1 is a block diagram of the shelf inventory management system according to the first embodiment. The shelf inventory management system is a system that manages the inventory of consumables stored in each of a plurality of storage boxes accommodated in the shelves, by using a computer. As shown in FIG. 1, the shelf inventory management system according to the present embodiment includes a shelf 50, a sorting robot 70, and a management unit 100.

The shelf 50 is a shelf for storing the consumables, and is installed in, for example, a living space of a house. In this specification, the house includes an apartment house, an office building, and the like, and the living space includes an office space. Here, FIG. 2 is a schematic front view showing an example of a configuration of the shelf 50. As shown in FIG. 2, the shelf 50 includes storage boxes 61 to 63 for storing the consumables. Further, as shown in FIGS. 1 and 2, mass sensors MS1 to MS3 for detecting the consumables taken out from the storage boxes 61 to 63 are provided. The details of the shelf 50 will be described later with reference to FIG. 2.

As shown in FIG. 1, the sorting robot 70 is a robot that sorts and stores purchased consumables in the storage boxes 61 to 63 based on instructions from the management unit 100. Although not shown, the sorting robot 70 includes, for example, a calculation unit such as a central processing unit (CPU) and a storage unit such as a random access memory (RAM) and a read only memory (ROM) in which various control programs, data, and the like are stored. That is, the sorting robot 70 has a function as a computer, and performs various processes based on the above-mentioned various control programs and the like. Details of the sorting robot 70 will be described later.

The management unit 100 is a computer that manages the inventory of the consumables stored in each of the storage boxes 61 to 63 on the shelf 50. The management unit 100 is, for example, a server such as a cloud server, and is provided separately from the shelf 50 and the sorting robot 70. The management unit 100 is not limited to a server as long as the management unit 100 has a function as a computer, and may be, for example, a mobile communication terminal such as a smartphone or a tablet terminal, a personal computer (PC), or the like. The management unit 100 may be provided integrally with the shelf 50, or may be provided integrally with the sorting robot 70.

As shown in FIG. 1, the management unit 100 is wirelessly or wiredly connected to the shelf 50 and the sorting robot 70 so as to be able to communicate with each other. The management unit 100 determines which consumable was taken out from which of the storage boxes 61 to 63 on the shelf 50, based on the mass change detected by the mass sensors MS1 to MS3 installed on the shelf 50.

Also, as shown in FIG. 1, the management unit 100 controls the sorting robot 70 so that the sorting robot 70 stores different kinds of consumables having the same mass in separate storage boxes 61 to 63 on the shelf 50 based on purchased article information. The purchased article information is information related to the purchased consumable, includes at least identification information and the mass of each purchased consumable, and is associated with each consumable. That is, the purchased article information is information that serves as the source of inventory information when the consumable is stored in any of the storage boxes 61 to 63.

As shown in FIG. 1, the management unit 100 includes a CPU 101, a ROM 102, a RAM 103, and an input/output (I/O) 104 as hardware. That is, the management unit 100 has a function as a computer, and performs various processes based on the above-mentioned various control programs and the like.

The CPU 101 is, for example, an arithmetic unit that performs control processing, arithmetic processing, and the like. The ROM 102 is, for example, a storage unit that stores a control program, an arithmetic program, and the like executed by the CPU 101. The RAM 103 is a storage unit that temporarily stores processed data and the like. In the RAM 103, for example, the identification information (for example, the name of the consumable, that is, the trade name) and the mass of each consumable stored in each of the storage boxes 61 to 63 on the shelf 50 are stored. The I/O 104 is an input/output device that inputs data and signals from the outside and outputs the data and signals to the outside.

As described above, the management unit 100 stores the inventory information such as the identification information and the mass of each consumable stored in each storage box 61 to 63 on the shelf 50. As shown in FIG. 1, the management unit 100 manages the consumables taken out from the storage boxes 61 to 63 on the shelf 50, based on the mass change that is the detection result of the mass sensors MS1 to MS3 installed on the shelf 50, and updates the inventory information. Further, the management unit 100 manages the consumables stored in the storage boxes 61 to 63 on the shelf 50, based on the purchased article information, and updates the inventory information. In this way, the management unit 100 manages the inventory of the storage boxes 61 to 63 on the shelf 50.

Here, when different kinds of consumables having the same mass are stored in one storage box 61 to 63, the management unit 100 cannot determine the consumables taken out based on the mass change of the storage box 61 to 63. The different kinds of consumables are, for example, consumables having different names (trade names). It should be noted that any of the same kind of consumables (for example, the same product) may be taken out, and it is not necessary to distinguish one from another.

However, in the shelf inventory management system according to the present embodiment, as described above, different kinds of consumables having the same mass are stored in separate storage boxes 61 to 63. Therefore, the consumables taken out can be reliably determined based on the mass change of the storage boxes 61 to 63. As a matter of course, the “same mass” has a predetermined allowable range. The allowable range is appropriately set according to the variation in the mass of the consumables, the accuracy of the mass sensors, and the like.

Configuration of Shelf 50

Here, details of the configuration of the shelf 50 will be described with reference to FIG. 2. As shown in FIG. 2, the shelf 50 includes a housing 51, partition plates 52, rails 53, lock mechanisms 54, the mass sensors MS1 to MS3, readers R11 to R14, R21 to R24, R31 to R34, and the storage boxes 61 to 63.

The right-handed xyz orthogonal coordinates shown in FIG. 2 are indicated for convenience to describe the positional relationship of the components. Generally, the z-axis positive direction is vertically upward, and the xy plane is a horizontal plane. FIG. 2 is a front view, and the storage boxes 61 to 63 are hatched for easy understanding. Further, the configuration of the shelf 50 shown in FIG. 2 is merely an example, and the configuration of the shelf 50 is not limited as long as the shelf 50 includes a plurality of storage boxes that is each identified.

The housing 51 constitutes the outer frame of the shelf 50. In the example shown in FIG. 2, the housing 51 has a frame structure in which a top plate provided on a side in the z-axis positive direction, a bottom plate provided on a side in the z-axis negative direction, side surface plates provided on a side in the y-axis positive direction and on a side in the y-axis negative direction are integrally formed. That is, the front and back surfaces of the housing 51 are open so that the storage boxes 61 to 63 can be taken in and out. Doors that can be opened and closed may be provided on the front and back surfaces of the open housing 51. Further, the front surface or the back surface of the housing 51 may be closed.

As shown in FIG. 2, the partition plates 52 are provided so as to be parallel to the side surface plates constituting the housing 51 (that is, parallel to the xz plane), and extend from the front surface to the back surface of the open housing 51. Here, the partition plates 52 are provided so that the distance between the side surface plates of the housing 51 and the adjacent partition plates 52 and the distance between the partition plates 52 are equal. In the example of FIG. 2, two partition plates 52 are provided, and three rows of the accommodation location for the storage boxes 61 to 63 are provided, but the number of partition plates 52 is not limited at all. Further, the configuration may be such that the partition plate 52 is not provided and one row of the accommodation location for the storage boxes 61 to 63 is provided.

As shown in FIG. 2, a plurality of pairs of the rails 53 is provided so as to extend in a depth direction (x-axis direction) and each of the rails 53 is arranged at equal intervals in a height direction (z-axis direction) on the inner surfaces of the housing 51 and the partition plates 52. Here, the rails 53 are provided so as to rise substantially perpendicularly from the inner surfaces of the housing 51 and the partition plates 52. In the example of FIG. 2, four pairs of the rails 53 are provided in each row, and four storage boxes 61 having the smallest size can be stored in each row.

As a matter of course, the number of the rails 53 is not limited at all. Further, the rails 53 may discontinuously extend in the depth direction (x-axis direction) as long as the rails 53 can support the storage boxes 61 to 63. Alternatively, instead of the rails 53, short supports may be arranged so as to be aligned in the depth direction (x-axis direction).

As shown in FIG. 2, the storage boxes 61 to 63 can be taken in and out by sliding protruding portions 61a to 63a on each of the rails 53 that faces adjacent to each other. The protruding portions 61a to 63a protrude outward from the storage boxes 61 to 63 in a width direction. In this way, the shelf 50 can accommodate all of the storage boxes 61 to 63 of a predetermined plurality of sizes, while supporting the storage boxes 61 to 63 so that the storage boxes 61 to 63 are slidable along each pair of the rails 53.

The lock mechanism 54 is provided on the upper side of each pair of the rails 53. The lock mechanism 54 locks the storage boxes 61 to 63 accommodated in the shelf 50 and their lids (not shown) to the housing 51, and can prevent the storage boxes 61 to 63 and the consumables stored inside the storage boxes 61 to 63 from being stolen. Details of the rails 53 and the lock mechanism 54 will be described later.

In the present embodiment, the storage boxes 61 to 63 of the predetermined plurality of sizes have the same width in the y-axis direction and the same depth in the x-axis direction. However, the storage boxes 61 to 63 have different heights in the z-axis direction. The height of the storage box 61 having the smallest size is designed so as to match the distance between the adjacent rails 53 in the z-axis direction. As a matter of course, the height of the storage box 61 having the smallest size is smaller than the distance between the rails 53 described above. The height of the storage box 62 having the intermediate size is designed to be about twice the height of the storage box 61. The height of the storage box 63 having the largest size is designed to be about three times the height of the storage box 61.

That is, the heights of the storage boxes 61 to 63 of the predetermined plurality of sizes are designed to be approximately an integral multiple of the distance between the adjacent rails 53 in the z-axis direction. In the example shown in FIG. 2, there are three types of sizes of the storage box, but two types or four or more types may be used. In the example of FIG. 2, in addition to the storage boxes 61 to 63, for example, a storage box having a height of about four times the height of the storage box 61 may be separately provided.

Consumables (not shown) such as groceries and daily necessities are stored inside the storage boxes 61 to 63. For example, when the consumables stored in the storage boxes 61 to 63 are taken out, the consumables are newly replenished.

Here, each storage box 61 to 63 is identified by the identification information such as characters, symbols, barcodes, two-dimensional codes, radio frequency identifiers (RDIF), etc. that can be read by the readers R11 to R14, R21 to R24, and R31 to R34, for example. Therefore, the management unit 100 shown in FIG. 1 can manage the inventory status of the consumables for each of the storage boxes 61 to 63 on the shelf 50. The identification information is directly attached to or embedded in each of the storage boxes 61 to 63. In the example shown in FIG. 2, the identification information (not shown) is provided to the side surfaces of the storage boxes 61 to 63 in the y-axis positive direction.

In the row on the side in the y-axis negative direction of the shelf 50 shown in FIG. 2, four readers R11 to R14 are provided on the partition plate 52 below each pair of the rails 53. In the central row, four readers R21 to R24 are provided on the partition plate 52 below each pair of the rails 53. In the row on the side in the y-axis positive direction, four readers R31 to R34 are provided on the side surface plate of the housing 51 below each pair of the rails 53.

By reading the identification information of the storage boxes 61 to 63 with the readers R11 to R14, R21 to R24, and R31 to R34, the storage boxes 61 to 63 accommodated in the shelf 50 can be identified and the storage location can be detected. Here, the identification information may include the sizes of the storage boxes 61 to 63. It should be noted that the readers R11 to R14, R21 to R24, and R31 to R34 may be omitted.

Further, in the shelf inventory management system according to the present embodiment, the consumables taken out are determined based on the mass change of each storage box 61 to 63. Therefore, as shown in FIG. 2, the shelf 50 is provided with the mass sensors MS1 to MS3 for each row. The mass sensors MS1 to MS3 may be installed at each storage location (for example, at each pair of the rails 53) so that the mass changes of the individual storage boxes 61 to 63 can be measured. However, as shown in FIG. 2, providing the mass sensor in each row can reduce the number of mass sensors.

Further, the shelf 50 does not necessarily have to be provided with the mass sensors, and the mass sensors may be provided separately from the shelf 50. When taking out the consumables from the storage boxes 61 to 63, for example, the storage boxes 61 to 63 may be placed on a mass sensor provided separately from the shelf 50 to measure the mass change of the storage boxes 61 to 63.

In the example of FIG. 2, when the consumables stored in either the two storage boxes 61 or the one storage box 62 accommodated in the row on the side in the y-axis negative direction are taken out, the mass detected by the mass sensor MS1 changes. When the consumables stored in either the two storage boxes 61 or the one storage box 62 accommodated in the central row are taken out, the mass detected by the mass sensor MS2 changes. When the consumables stored in either the storage box 61 or the storage box 63 accommodated in the row on the side in the y-axis positive direction are taken out, the mass detected by the mass sensor MS3 changes.

The mass change detected by the mass sensors MS1 to MS3 is the mass of the consumables taken out. The storage box 61 to 63 from which the consumables were taken out can be determined by detecting that the storage box 61 to 63 accommodated in the row in which the mass change is recognized is pulled out from the shelf 50. The fact that the storage box 61 to 63 is pulled out from the shelf 50 can be easily detected by, for example, the readers R11 to R14, R21 to R24, and R31 to R34, and the unlocking operation of the lock mechanism 54 described later. It goes without saying that the fact that the storage box 61 to 63 is pulled out from the shelf 50 may also be detected by a camera or other sensors.

As described above, the management unit 100 stores the kinds, masses, and the like of the consumables stored in the storage boxes 61 to 63. Therefore, the management unit 100 can determine the consumables taken out based on the mass change detected by the mass sensors MS1 to MS3.

Details of Rail 53 and Lock Mechanism 54

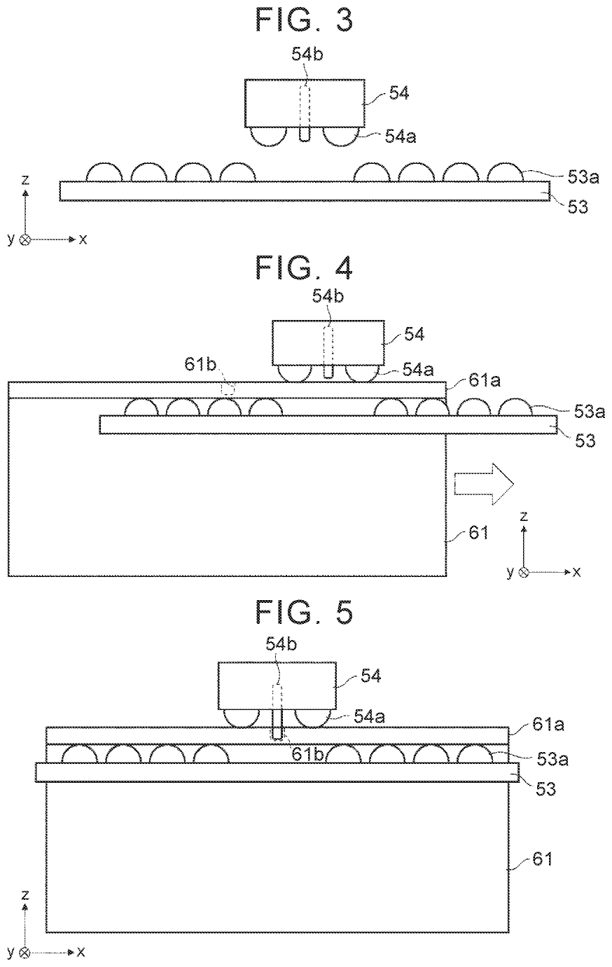

Here, the details of the rail 53 and the lock mechanism 54 will be described with reference to FIGS. 3 to 5. FIGS. 3 to 5 are schematic side views showing the rail 53 and the lock mechanism 54. FIGS. 3 to 5 show the positional relationship between the rail 53, the lock mechanism 54, and the storage box 61 as seen from the side in the y-axis negative direction in FIG. 2. The same applies to the positional relationship between the rail 53, the lock mechanism 54, and the storage box 62.

As shown in FIG. 3, the rail 53 is a roller rail and includes rollers 53a. The rollers 53a are made of, for example, plastic. The rollers 53a can reduce the friction coefficient between the protruding portion 61a of the storage box 61 and the rail 53, and can suppress the generation of abrasion powder due to the sliding of the protruding portion 61a.

The lock mechanism 54 shown in FIG. 3 is a solenoid lock and includes rollers 54a and a pin 54b. The lock mechanism 54 is provided so as to face each rail 53. As shown in FIGS. 4 and 5, the lock mechanism 54 is provided so as to slide with the protruding portion 61a of the storage box 61, and the rollers 54a are provided on the surface of the lock mechanism 54 that slides with the protruding portion 61a. The rollers 54a are made of, for example, plastic. The rollers 54a can reduce the friction coefficient between the protruding portion 61a of the storage box 61 and the lock mechanism 54, and can suppress the generation of abrasion powder due to the sliding of the protruding portion 61a.

As shown in FIG. 4, the lock mechanism 54 is released while the storage box 61 slides on the rail 53. Therefore, the pin 54b is retracted upward. On the other hand, as shown in FIG. 5, when the storage box 61 stops at a predetermined position on the rail 53, the lock mechanism 54 operates.

Specifically, the pin 54b advances downward and fits into a recess 61b provided in the protruding portion 61a of the storage box 61, whereby the storage box 61 is fixed to the housing 51 and the lid (not shown) of the storage box 61 is locked. As a matter of course, when the lock mechanism 54 is released, the storage box 61 can be moved again as shown in FIG. 4.

The lock mechanism 54 can prevent the storage box 61 and the consumables stored in the storage box 61 from being stolen. Further, the management unit 100 shown in FIG. 1 detects that the storage box 61 is locked. As a result, the management unit 100 can determine the rails 53 where the storage boxes 61 to 63 are accommodated. The storage box 61 is locked while the storage box 61 is accommodated in the shelf 50.

On the other hand, when taking out the consumables from the storage boxes 61 to 63, the management unit 100 shown in FIG. 1 detects that the locks of the storage boxes 61 to 63 have been released. That is, the management unit 100 detects that the storage boxes 61 to 63 have been pulled out from the shelf 50. As a result, the management unit 100 determines that the consumables have been taken out from the storage boxes 61 to 63 pulled out.

The lock mechanism 54 is not limited to the solenoid lock, and may be any mechanism that can restrict the operation of the storage box 61 and lock the lid (not shown) of the storage box 61. For example, the pin 54b may operate mechanically. Alternatively, a rotary lock mechanism that does not use the pin 54b may be used. Further, the lock for the operation of the storage box 61 and the lock for the lid of the storage box 61 may be locked separately.

Configuration of Sorting Robot 70

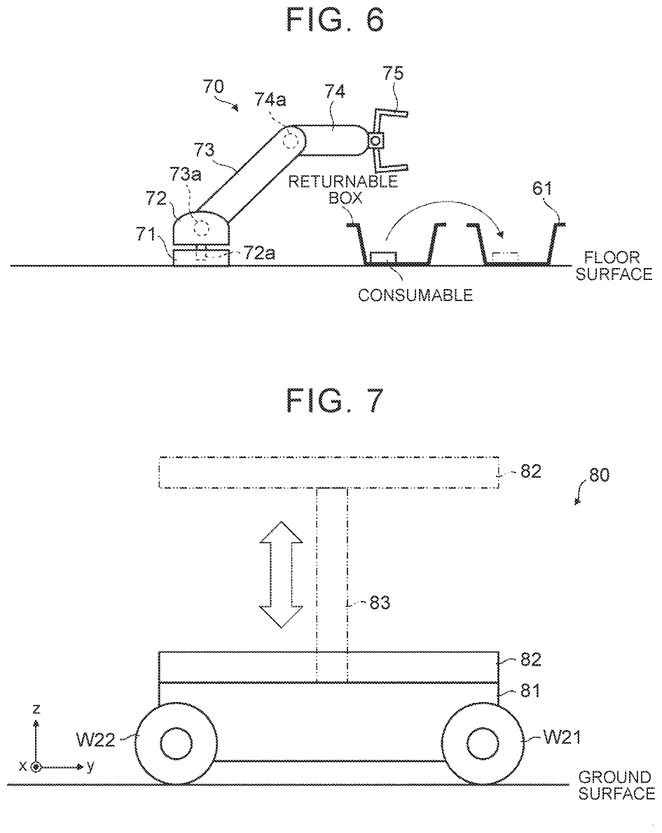

Next, an example of a configuration of the sorting robot 70 will be described with reference to FIG. 6. FIG. 6 is a schematic side view showing an example of the configuration of the sorting robot 70. The sorting robot 70 is a manipulator including a base portion 71, a link root portion 72, a first link 73, a second link 74, and an end effector 75. The consumables are gripped by the end effector 75 and transferred to the storage boxes 61 to 63. FIG. 6 shows how a consumable is transferred from a returnable box for delivering the consumable to the storage box 61. The same applies to the storage boxes 62 and 63.

The configuration of the end effector 75 is not limited as long as the consumables can be transferred by the end effector 75. For example, the end effector 75 may adsorb and transfer the consumables. Further, in the example shown in FIG. 6, the link mechanism is composed of two links, the first link 73 and the second link 74, but the link mechanism may be composed of three or more links.

The base portion 71 is fixed to the floor surface in the living space of the house, for example. The link root portion 72 is connected to the base portion 71 via a rotation shaft 72a so as to be rotatable around the rotation shaft 72a. The rotation shaft 72a of the link root portion 72 is an axis perpendicular to the floor surface. The link root portion 72 is rotationally driven by a motor or the like (not shown).

The first link 73 is pivotably connected to the link root portion 72 via a first joint portion 73a provided at the rear end of the first link 73. Further, the second link 74 is pivotably connected to the front end of the first link 73 via a second joint portion 74a provided at the rear end of the second link 74. The end effector 75 is connected to the front end of the second link 74.

Here, the rotation axes of the first joint portion 73a and the second joint portion 74a are axes parallel to the floor surface. The height of the end effector 75 can be changed by pivoting the first link 73 and the second link 74. The first link 73 and the second link 74 are each rotationally driven by a motor or the like (not shown). With such a configuration, the consumables can be sorted and stored in the storage boxes 61 to 63 by the sorting robot 70.

Although not shown, the sorting robot 70 also includes, for example, a calculation unit such as a CPU and a storage unit such as a RAM and a ROM in which various control programs and data are stored. That is, the sorting robot 70 also has a function as a computer, and executes various control processes based on the above-mentioned various control programs and the like.

Configuration of Transfer Robot 80

Next, with reference to FIG. 7, a configuration of a transfer robot 80 for moving the storage boxes 61 to 63 in and out of the shelf 50 will be described. FIG. 7 is a schematic side view showing an example of the configuration of the transfer robot 80. The transfer robot 80 may be omitted and is not shown in FIG. 1.

The transfer robot 80 shown in FIG. 7 is an autonomous traveling vehicle that takes the storage boxes 61 to 63 (that is, the consumables) in and out from the shelf 50. As shown in FIG. 7, the transfer robot 80 includes wheels W21 and W22, a main body portion 81, a top plate 82, and a support column 83.

Two pairs of the wheels W21 and W22 are rotatably fixed to the lower side of the main body portion 81, and are driven by a drive source (not shown) such as a motor. As shown in FIG. 7, the top plate 82 is connected to the main body portion 81 via the support column 83 capable of expanding and contracting. The top plate 82 is connected to the upper end of the support column 83, and the transfer robot 80 places the storage boxes 61 to 63 on the top plate 82 to transfer the storage boxes 61 to 63. Here, instead of the shelf 50 including the mass sensors MS1 to MS3, the transfer robot 80 may include the mass sensors and measure the mass change of the storage boxes 61 to 63 from which the consumables are taken out.

The support column 83 has, for example, a telescopic type expansion and contraction mechanism, and is expanded and contracted by a drive source (not shown) such as a motor. As shown by the white arrow in FIG. 7, the height of the top plate 82 can be changed by changing the length of the support column 83. Therefore, the storage boxes 61 to 63 can be taken in and out at any accommodation location of the shelf 50.

Here, the transfer robot 80 is provided with, for example, a manipulator (not shown), and the manipulator moves the storage boxes 61 to 63 from the shelf 50 onto the top plate 82 to transfer the storage boxes 61 to 63. The manipulator also moves the storage boxes 61 to 63 on the top plate 82 to the shelf 50.

Although not shown, the transfer robot 80 also includes, for example, a calculation unit such as a CPU and a storage unit such as a RAM and a ROM in which various control programs and data are stored. That is, the transfer robot 80 also has a function as a computer, and executes various control processes based on the above-mentioned various control programs and the like.

Shelf Inventory Management Method

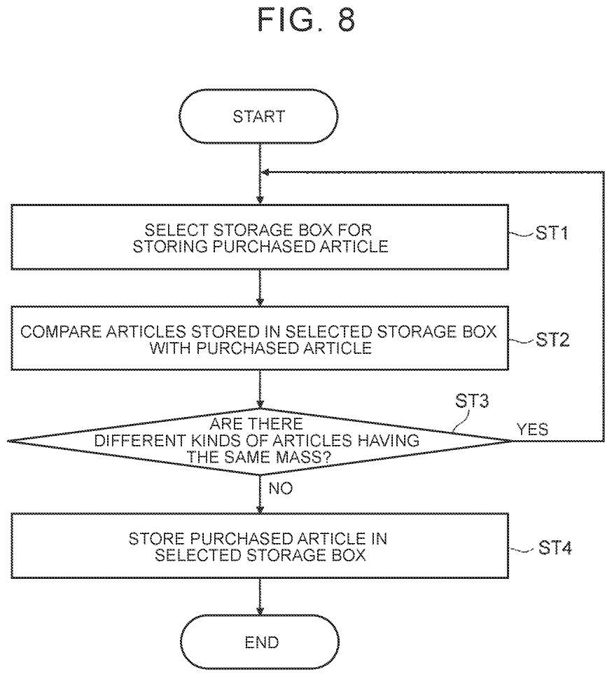

Next, a shelf inventory management method according to the first embodiment will be described with reference to FIG. 8. FIG. 8 is a flowchart showing the shelf inventory management method according to the first embodiment.

First, as shown in FIG. 8, the management unit 100 selects the storage box 61 to 63 for storing the purchased consumable (purchased article) based on the purchased article information (step ST1). Next, the management unit 100 compares the consumables stored in the selected storage box 61 to 63 with the purchased article (step ST2).

When the consumables stored in the selected storage box 61 to 63 include different kinds of consumables having the same mass as the purchased article (step ST3: YES), the process returns to step ST1 and another storage box 61 to 63 is selected. On the other hand, when the consumables stored in the selected storage box 61 to 63 do not include different kinds of consumables having the same mass as the purchased article (step ST3: NO), the management unit 100 controls the sorting robot 70 so that the sorting robot 70 stores the purchased article in the selected storage box 61 to 63 (step ST4).

As described above, in the shelf inventory management method according to the present embodiment, the management unit 100 controls the sorting robot 70 so that the sorting robot 70 stores different kinds of consumables having the same mass in separate storage boxes 61 to 63.

Here, when different kinds of consumables having the same mass are stored in one storage box, the management unit 100 cannot determine the consumable taken out based on the mass change of the storage boxes 61 to 63. However, in the shelf inventory management method according to the present embodiment, as described above, different kinds of consumables having the same mass are stored in separate storage boxes 61 to 63. Therefore, the consumable taken out can be reliably determined based on the mass change of the storage boxes 61 to 63.

### Second Embodiment

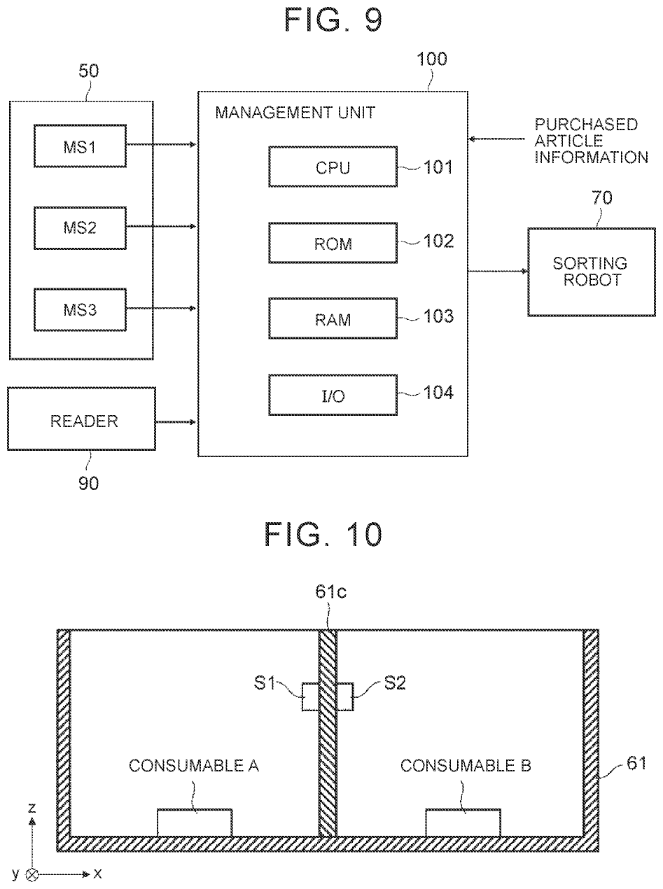

Next, a shelf inventory management system according to a second embodiment will be described with reference to FIG. 9. FIG. 9 is a block diagram of the shelf inventory management system according to the second embodiment. As shown in FIG. 9, the shelf inventory management system according to the present embodiment includes a reader 90 in addition to the shelf 50, the sorting robot 70, and the management unit 100 shown in FIG. 1

In the shelf inventory management system according to the first embodiment, different kinds of consumables having the same mass can be stored only up to the number of the storage boxes 61 to 63 on the shelf 50. In other words, when the number of consumables having the same mass exceeds the number of the storage boxes 61 to 63 on the shelf 50, it is necessary to store different kinds of consumables having the same mass in one storage box.

Therefore, in the shelf inventory management system according to the present embodiment, only when it is necessary to store different kinds of consumables having the same mass in one storage box, article identification information is provided to the consumable that is stored later. The management unit 100 permits the sorting robot 70 to store different kinds of consumables having the same mass in one storage box when the consumable is provided with the article identification information. The article identification information includes characters, symbols, barcodes, two-dimensional codes, RFID, etc. that can be read by the reader 90.

The reader 90 is hardware that reads the article identification information provided to the consumables, and is communicably connected to the management unit 100. The reader 90 may be provided separately from the shelf 50, the sorting robot 70, and the management unit 100, or may be provided integrally with the shelf 50, the sorting robot 70, or the management unit 100. Alternatively, the reader 90 may be provided integrally with the transfer robot 80.

In the case where a consumable is taken out from the storage box 61 to 63, when a plurality of kinds of consumables having a mass corresponding to the mass change detected by the mass sensor MS1 to MS3 is stored in the storage box, the reader 90 reads the article identification information of the above consumable. Therefore, the management unit 100 can determine the consumable taken out based on the article identification information acquired from the reader 90.

Of the plurality of kinds of consumables having the same mass stored in one storage box 61 to 63, the consumable stored first is not provided with the article identification information. However, since the article identification information of the consumable cannot be read by the reader 90, the consumable can be distinguished from other kinds of consumables having the same mass.

As described above, in the shelf inventory management system according to the present embodiment, only when it is necessary to store different kinds of consumables having the same mass in one storage box, the article identification information is provided to the consumable. The management unit 100 permits the sorting robot 70 to store different kinds of consumables having the same mass in one storage box when the consumable is provided with the article identification information. Further, when the consumable is taken out from the storage box 61 to 63, the article identification information of the consumable is read by the reader 90.

Therefore, the management unit 100 can reliably determine the consumable taken out based on the mass change of the storage boxes 61 to 63 and the article identification information. Here, only when it is necessary to store different kinds of consumables having the same mass in one storage box, the article identification information is provided only to the above consumable. Thus, it is possible to save the trouble of providing and reading the article identification information as compared with the case where the article identification information is provided to all the consumables. Since other configurations are the same as those of the first embodiment, the description thereof will be omitted.

### Third Embodiment

Next, a shelf inventory management system according to a third embodiment will be described with reference to FIG. 10. FIG. 10 is a sectional view of the storage box 61 used in the shelf inventory management system according to the third embodiment. The storage box 61 will be described as an example, but the same applies to the storage boxes 62 and 63.

In the shelf inventory management system according to the first embodiment, different kinds of consumables having the same mass can be stored only up to the number of storage boxes 61 to 63 on the shelf 50. In other words, when the number of consumables having the same mass exceeds the number of storage boxes 61 to 63 on the shelf 50, it is necessary to store different kinds of consumables having the same mass in one storage box.

Therefore, in the shelf inventory management system according to the present embodiment, only when it is necessary to store different kinds of consumables having the same mass in one storage box, a partition plate 61c is provided in the storage box 61. The management unit 100 controls the sorting robot 70 so that the sorting robot 70 stores different kinds of consumables having the same mass in separate areas partitioned by the partition plate 61c in the storage box. In the example shown in FIG. 10, different kinds of consumables A and B having the same mass are stored in separate areas partitioned by the partition plate 61c.

As shown in FIG. 10, sensors S1 and S2 for detecting an object are respectively provided on each side of the partition plate 61c. The sensors S1 and S2 can detect that the consumables stored in separate areas partitioned by the partition plate 61c have been taken out. In the example shown in FIG. 10, the sensor S1 can detect that the consumable A has been taken out. On the other hand, the sensor S2 can detect that the consumable B has been taken out.

The detection information of the consumables A and B from the sensors S1 and S2 is input to the management unit 100. Therefore, the management unit 100 can reliably determine whether the consumable taken out is either the consumable A or the consumable B based on the mass change of the storage box 61 detected by the mass sensor MS1 to MS3 and the detection information of the object from the sensors S1 and S2. Even when only one of the sensors S1 and S2 is provided, it is possible to reliably determine whether the consumable taken out is either the consumable A or the consumable B. Since other configurations are the same as those of the first embodiment, the description thereof will be omitted.

In the examples described above, various control programs can be stored using various types of non-transitory computer-readable media and supplied to a computer. The non-transitory computer-readable media include various types of tangible storage media. Examples of the non-transitory computer-readable media include magnetic recording media (e.g. flexible disks, magnetic tapes, hard disk drives), magneto-optical recording media (e.g. magneto-optical disks), compact disc ROM (CD-ROM), compact disc recordable (CD-R), compact disc rewritable (CD-R/W), and semiconductor memory (e.g. mask ROM, programmable ROM (PROM), erasable PROM (EPROM), flash ROM, RAM). The program may also be supplied to the computer by various types of transitory computer-readable media. Examples of the transitory computer-readable media include electrical signals, optical signals, and electromagnetic waves. The transitory computer-readable media can supply the program to the computer via a wired communication path such as an electric wire and an optical fiber, or a wireless communication path.

The present disclosure is not limited to the above embodiments, and can be appropriately modified without departing from the spirit.

What is claimed is:

1. A shelf inventory management system comprising:
a shelf including a plurality of storage boxes, each of which is identified;
a mass sensor that detects a mass change of the storage boxes; and
a management unit that manages an inventory of articles stored in each of the storage boxes, wherein
the management unit determines an article taken out from any of the storage boxes, based on the mass change detected by the mass sensor,
the shelf inventory management system further includes a sorting robot that sorts purchased articles into the storage boxes, and
the management unit controls the sorting robot such that the sorting robot stores different kinds of articles having the same mass in separate storage boxes.

2. The shelf inventory management system according to claim 1, further comprising a reader that reads article identification information provided to the article, wherein:
when it is necessary to store different kinds of articles having the same mass in one storage box, the shelf inventory management system provides the article identification information to at least one of the different kinds of articles having the same mass; and
the management unit permits the sorting robot to store different kinds of articles having the same mass in one storage box when the article is provided with the article identification information.

3. The shelf inventory management system according to claim 1, wherein:
when it is necessary to store different kinds of articles having the same mass in one storage box, the shelf inventory management system provides a partition plate equipped with a sensor for detecting an object in the one storage box; and
the management unit controls the sorting robot such that the sorting robot stores different kinds of articles having the same mass in separate areas partitioned by the partition plate in the one storage box.

4. A shelf inventory management method for managing, using a computer, an inventory of articles stored in each of a plurality of storage boxes in a shelf including the storage boxes, each of which is identified, the shelf inventory management method comprising:
controlling, when sorting purchased articles into the storage boxes, a sorting robot such that the sorting robot stores different kinds of articles having the same mass in separate storage boxes; and
determining, when taking out an article from any of the storage boxes, the article taken out based on a mass change of the storage boxes.

5. The shelf inventory management method according to claim 4, comprising:
providing, when it is necessary to store different kinds of articles having the same mass in one storage box, article identification information to at least one of the different kinds of articles having the same mass;
permitting the sorting robot to store different kinds of articles having the same mass in one storage box when the article is provided with the article identification information; and
reading, when the article provided with the article identification information is taken out, the article identification information by a reader to determine the article taken out.

6. The shelf inventory management method according to claim 4, comprising:
providing, when it is necessary to store different kinds of articles having the same mass in one storage box, a partition plate equipped with a sensor for detecting an object in the one storage box; and
controlling the sorting robot such that the sorting robot stores different kinds of articles having the same mass in separate areas partitioned by the partition plate in the one storage box.

7. A program for managing, using a computer, an inventory of articles stored in each of a plurality of storage boxes in a shelf including the storage boxes, each of which is identified, wherein:
when a sorting robot sorts and stores articles in the storage boxes, the program controls the sorting robot such that the sorting robot stores different kinds of articles having the same mass in separate storage boxes; and
when taking out an article from any of the storage boxes, the program determines the article taken out based on a mass change of the storage boxes.
